(19) United States
(12) Patent Application Publication
(10) Pub. No.: US 2022/0192405 A1
(43) Pub. Date: Jun. 23, 2022

(54) WHEAT PLASTIC CLOTHES HANGER

(71) Applicant: Honey-Can-Do International, LLC, Berkeley, IL (US)

(72) Inventors: Steven B. Greenspon, Burr Ridge, IL (US); Valerie Snow, Chicago, IL (US)

(73) Assignee: Honey-Can-Do International, LLC, Berkeley, IL (US)

(21) Appl. No.: 17/124,644

(22) Filed: Dec. 17, 2020

(51) Int. Cl. A47G 25/36; B29C 45/00

(52) U.S. Cl. CPC A47G 25/36; B29L 2031/735; B29C 45/0001

(57) ABSTRACT

A method of manufacturing a clothes hanger is disclosed. The method includes adding ingredients into an injection machine. The ingredients made up of a wheat Fiber, a polypropylene, a polyethylene wax and a Talc Powder. The method heats and mixes the ingredients to melt the ingredients forming a composite mixture. The composite material is extruded into a mold, forming the hanger base. The hanger base is extracted from the injection machine and a hanger hook is inserted into the hanger neck.

### BACKGROUND OF THE INVENTION

The present invention relates to clothes hangers and more particularly to clothes hangers made for wheat straw plastic composite materials. This provides a more eco-friendly material as an alternative to straight thermoplastic material currently used to make clothes hangers.

### SUMMARY OF THE INVENTION

One or more of the embodiments provided in the present invention relates to a process of manufacturing a wheat straw plastic hanger, which includes the steps: adding ingredients into an injection machine. The ingredients made up of a wheat Fiber, a polypropylene, a polyethylene wax and a Talc Powder. The method heats and mixes the ingredients to melt the ingredients forming a composite mixture. The composite material is extruded into a mold, forming the hanger base. The hanger base is extracted from the injection machine and a hanger hook is inserted into the hanger neck. In addition, a colorant can be added to the composite material prior to extrusion.

Numerous other advantages and features of the invention will become readily apparent from the following detailed description of the invention and the embodiments thereof, from the claims, and from the accompanying drawings

### DESCRIPTION OF THE DRAWINGS

A fuller understanding of the foregoing may be had by reference to the accompanying drawings, wherein:

FIGS. 1 and 2 illustrate a hanger manufactured in accordance with an embodiment of the present invention;

FIG. 3 is a flow chart illustrating the manufacturing method in accordance with an embodiment of the present invention; and

FIGS. 4 and 8 illustrate various states in the manufacturing process in accordance with an embodiment of the present invention.

### DETAILED DESCRIPTION OF THE INVENTION

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or the embodiments illustrated.

As stated above, the problem is unrestrained sound waves created from drum cymbals and guitar amplifiers that are picked up by the singer's microphones. The invention claimed here solves this problem.

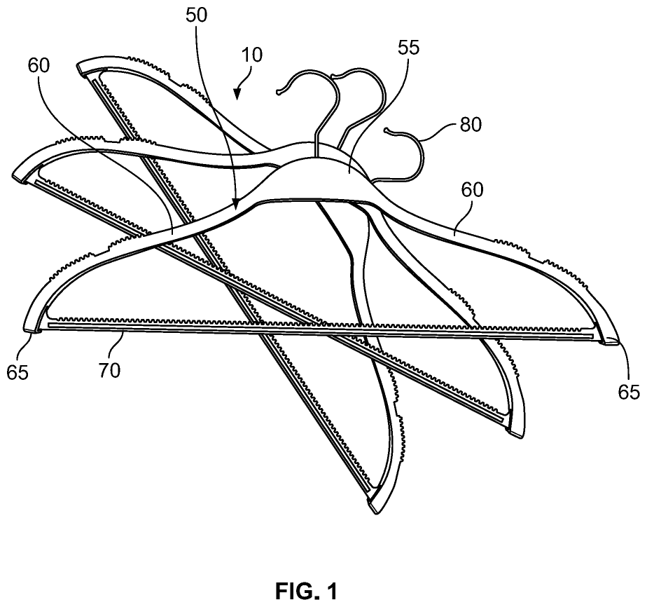

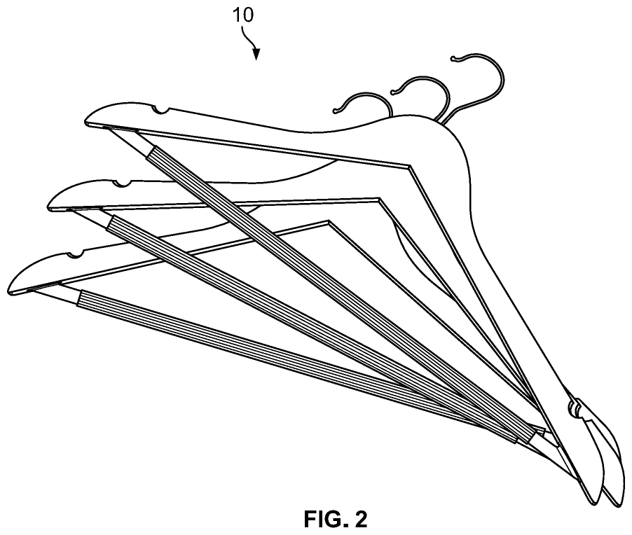

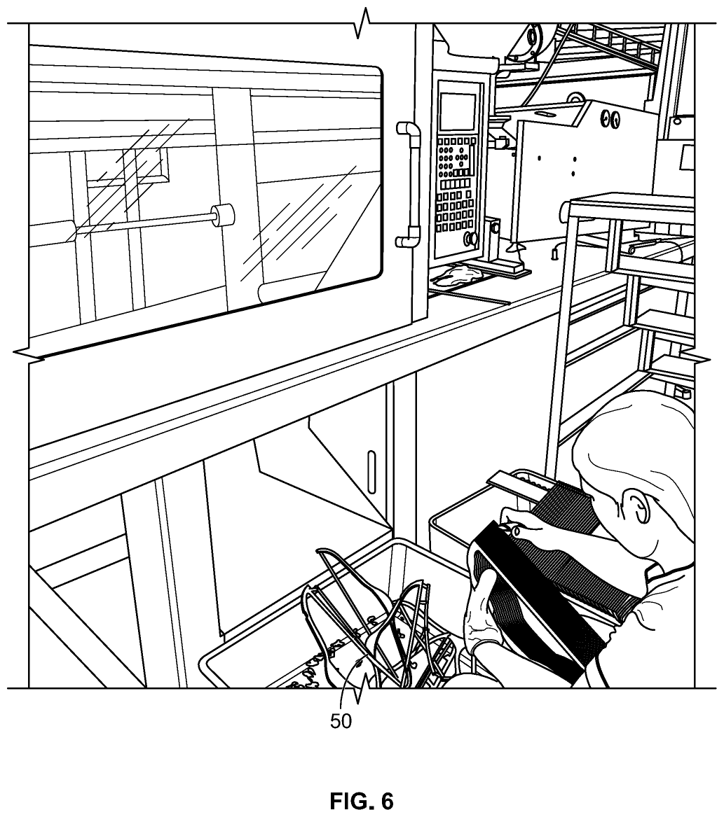

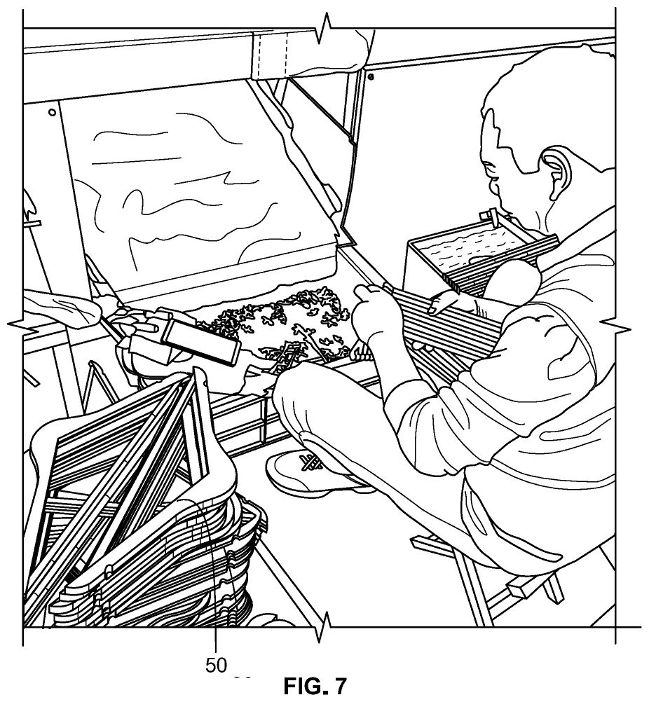

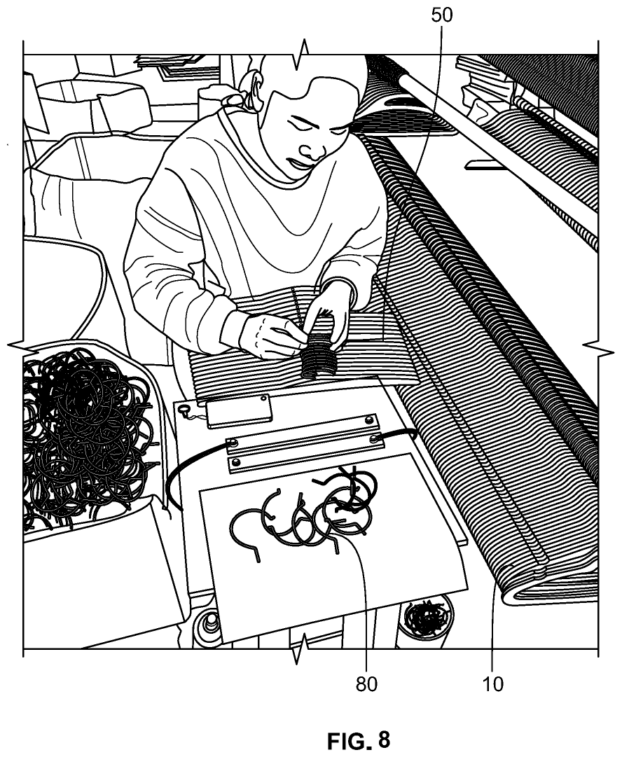

Referring to FIG. 1-8, there is shown a finished clothes hanger 10 being made from a composite material derived in part from wheat straw. The hanger 10 includes a hanger base 50 and a hanger hook 80. The hanger base 50 includes a top neck 55 that extends outwardly on either side into a pair of arms 60. Each of the arms 60 curves outwardly and downwardly towards a bottom end 65. A lateral support member 70 typically extends and connects adjacent to the bottom ends 65 of each arm 60. Lastly, a hanger hook 80 is connected and extends from the top neck 55.

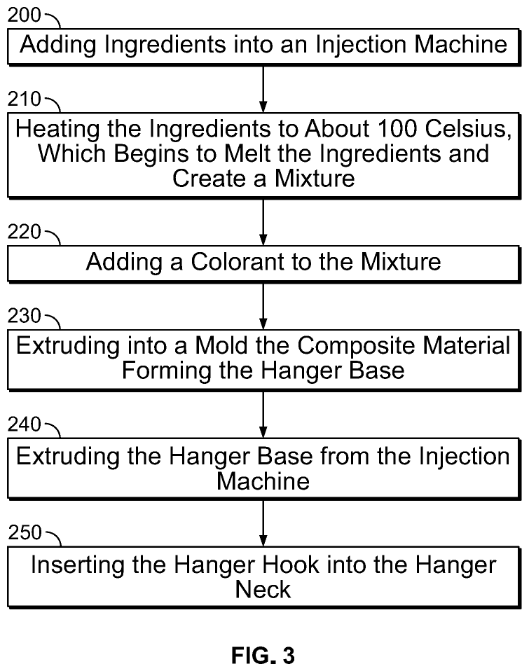

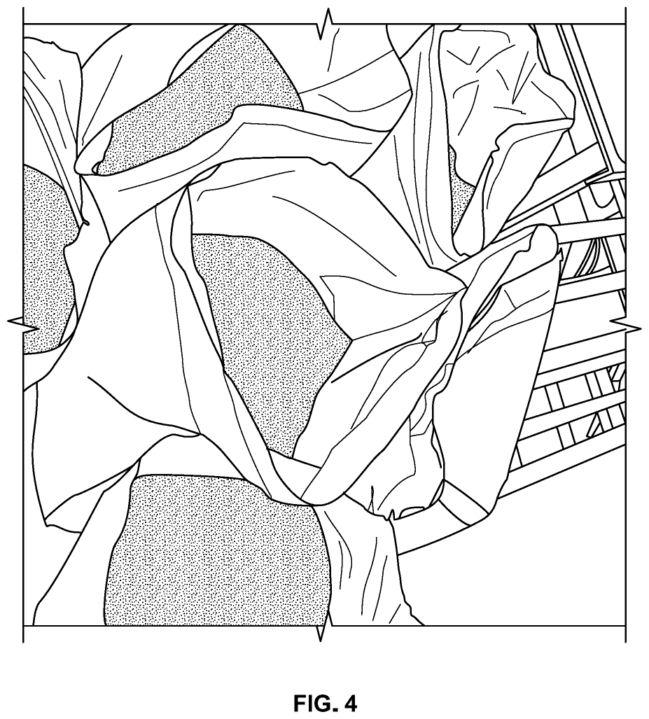

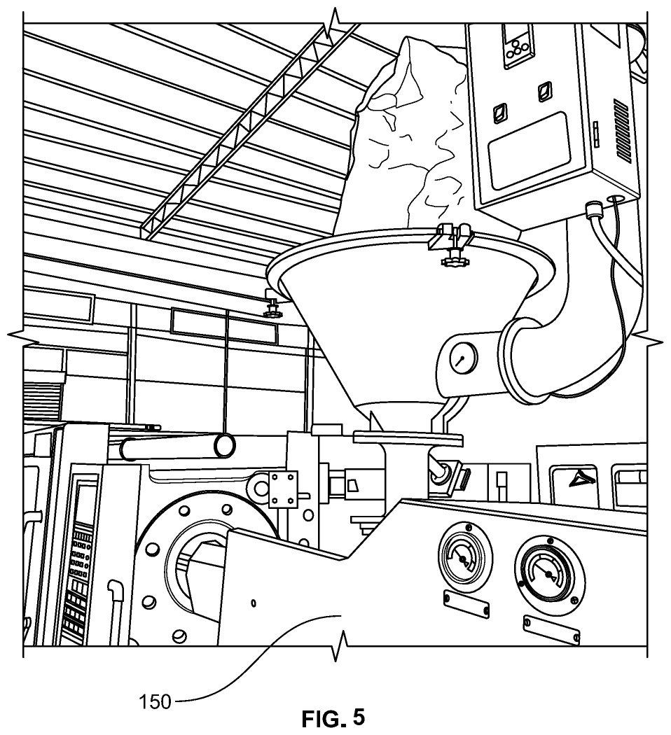

In one embodiment of the invention, the hanger 10 is manufactured under the following steps and in reference to FIG. 3, which include:
a. Adding the ingredients into an injection machine 150, Box 200;
b. Heating the ingredients, preferably to about 100 Celsius, to melts the ingredients creating a mixture or composite material, Box 210;
c. Adding a colorant to the mixture, Box 220;
d. Extruding into a mold the composite material forming the hanger base, Box 230;
e. Extracting the hanger base from the injection machine, Box 240; and
f. Inserting the hanger hook into the hanger neck, Box 250.

As preferred the creation of the composite material is manufactured from the following:
a. Wheat Straw Fiber about 30%-40% weight of the total weight, with a preferred 35%;
b. Polypropylene 50%-60% weight of the total weight, with a preferred 59%;
c. Polyethylene wax about 1%-4% weight of the total weight, with a preferred 2%; and
d. Talc Powder about 2%-6% weight of the total weight, with a preferred 4%.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

We claim:

1. A method of manufacturing a clothes hanger comprising:
adding ingredients into an injection machine; wherein the ingredients comprise:
a wheat straw Fiber, a polypropylene, a polyethylene wax and a Talc Powder;
heating and mixing the ingredients to melts the ingredients forming a composite material;
extruding the composite material into a mold, forming the hanger base;
extracting the hanger base from the injection machine; and
inserting the hanger hook into the hanger neck.

2. The method of claim 1 further comprising:
adding a colorant to the composite mixture prior to extruding the composite material.

3. The method of claim 1, wherein the heating step is further defined as heating the ingredients to about 100 Celsius.

4. The method of claim 1, wherein the ingredients are preferably provided in the following:
a. Wheat Straw Fiber added to about 30%-40% weight of the total weight of the composite material;
b. Polypropylene added to about 50%-60% weight of the total weight of the composite material;
c. Polyethylene wax added to about 1%-4% weight of the total weight of the composite material; and
d. Talc Powder added to about 2%-6% weight of the total weight of the composite material.

5. The method of claim 1, wherein the ingredients are preferably provided in the following:
a. Wheat Straw Fiber added to about 35% weight of the total weight of the composite material;
b. Polypropylene added to about 59% weight of the total weight of the composite material;
c. Polyethylene wax added to about 2% weight of the total weight of the composite material; and
d. Talc Powder added to about 4% weight of the total weight of the composite material.

6. A method of manufacturing a clothes hanger out of wheat straw fiber, the method comprising:
adding a wheat straw fiber, a polypropylene, a polyethylene wax and a Talc Powder into an injection machine to form a mixture;
heating the mixture to form a composite material;
extruding the composite material into a mold, forming the hanger base;
extracting the hanger base from the injection machine; and
inserting the hanger hook into the hanger neck.

7. The method of claim 6 further comprising:
adding a colorant to the composite mixture prior to extruding the composite material.

8. The method of claim 6, wherein the ingredients are preferably provided in the following:
e. Wheat Straw Fiber added to about 30%-40% weight of the total weight of the composite material;
f. Polypropylene added to about 50%-60% weight of the total weight of the composite material;
g. Polyethylene wax added to about 1%-4% weight of the total weight of the composite material; and
h. Talc Powder added to about 2%-6% weight of the total weight of the composite material.

9. The method of claim 6, wherein the ingredients are preferably provided in the following:
e. Wheat Straw Fiber added to about 35% weight of the total weight of the composite material;
f. Polypropylene added to about 59% weight of the total weight of the composite material;
g. Polyethylene wax added to about 2% weight of the total weight of the composite material; and
h. Talc Powder added to about 4% weight of the total weight of the composite material.
